(19) United States
(12) Patent Application Publication
(10) Pub. No.: US 2009/0297756 A1
(43) Pub. Date: Dec. 3, 2009

(54) Ventilation Insert

(76) Inventor: Michael C. Dehn, Hamburg (DE)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 11/991,593

(22) PCT Filed: Sep. 6, 2006
(86) PCT No.: PCT/EP2006/008691

§ 371 Date: Mar. 25, 2009

(30) Foreign Application Priority Data
Sep. 6, 2005 (DE) 10 2005 043 069.4
Oct. 21, 2005 (DE) 10 2005 051 575.4

(51) Int. Cl. B32B 3/26; B32B 3/12

(52) U.S. Cl. 428/68; 428/316.6; 428/158; 428/116

(57) ABSTRACT

The invention relates to a ventilation insert for ventilating textiles, shoes and soles of shoes, gloves, protective helmets and their visors, protective goggles, insulating mats, cushioning mats, knee pads and shin pads, headgear and similar articles. The invention proposes a ventilation insert in which an open-pored support layer (1) is provided with an open-pored cover (1.1, 10) or individual covering elements (2) which are at least partly composed of a material (3) which undergoes a swelling or shrinking effect on account of moisture, heat or an electrical voltage, or a material (3) of this type is connected to the support layer (1), the cover (1.1, 10) and/or the covering elements (2) or constitutes the support layer or cover in such a way that ventilation openings (5, 12) in the support layer (1) and/or in the cover (1.1, 10) are exposed or closed on account of the swelling or shrinking effect.

The invention relates to a ventilation insert for ventilating textiles, shoes and soles of shoes, gloves, protective helmets and their visors, protective goggles, insulating mats, cushioning mats, knee pads and shin pads, headgear and similar articles.

Previously known ventilation for the named articles essentially uses micro fibers, open-pored materials, or ventilation openings.

Openings or open-pored materials still offer the most effective possibility for air exchange and the concomitant release of water vapor and heat. Openings or perforations through the material, for example in jackets, employ solutions such as zippers or hook-and-loop (Velcro) fasteners that with manual opening and closing prevent penetration of water or allow for ventilation. It is also possible with the use of fiber layers to cover the openings and prevent penetration of water.

Shoes often have openings in the top portion that are connected in part with structures, for example lamellas, that are supposed to provide for improved supply of external air or exhaust water vapor. Some shoes have openings in the sole of the shoe. These openings are covered with a special membrane or a fiber layer in order to avoid penetration of water and foreign objects.

Special membranes or fiber layers in which ventilation openings are to be protected from penetration of water and foreign objects prevent to a considerable degree the circulation of air and thus removal of used air or water vapor. As regards use of special membranes, it is a matter of laboratory models that in fact mostly fail to yield noticeable success. Materials of this kind also have the disadvantage that they are permeable from only one side. That is, if water vapor is to exit, it is not possible for external air to enter due to the properties of the material, namely the orientation of the capillaries.

Attempts at a solution are already known according to which fibers of textile surfaces are coated or impregnated with an elastomer (a so-called super absorbent) so that they swell up when in contact with water and seal by means of an increase of volume due to the water in the interstices between the fibers and thus prevent penetration of water. The use of super absorption in textile surfaces turns out to be disadvantageous in that corresponding textiles fill their entire surfaces with water leading to a large increase in their weight. There is also the disadvantage that super absorbents cannot permanently be connected with textile fibers, that they do not seal permanently, and that corresponding textiles often evince a jell-like consistency after absorption of moisture that is often felt to be unpleasant.

The most effective possibility for ventilation is still the use of open-pored materials or openings. Different openings in textiles and shoes offer the possibility of protection by hand using covering elements against entry of water. Appropriate covering elements are preferably fastened in place by zippers or hook-and-loop fasteners or they are fixed constituents of textiles and shoes that can be adjusted as to their position by turning or pushing.

These solutions previously mentioned have a disadvantage, however, in that water can penetrate, that they allow insufficiently for ventilation, or that they must be protected by hand against penetration of fluids.

Super absorbents are also used in the construction industry to seal against leaks, for example in deep sea cables and for waterproofing roofs. In these cases it is a matter of sealing against penetration of fluids and not of protection of ventilation openings.

Fiber layers that prevent penetration of water by absorbing moisture have the disadvantage that they let air through only to a much reduced amount because of their relatively great thickness and material strength. In addition, they can conduct water into the internal spaces due to their capillary action (moisture bridge). They thus take a long time to dry out again. Formation of mold and bacteria is possible.

A compromise had to be entered into up to now between wearing comfort and function in order to prevent penetration of water and dirt.

The invention addresses the task of creating a ventilation insert with ventilation openings that close independently in the presence of moisture or low temperatures and thus prevent penetration of water or cold air. They must dry out quickly and in drying or with rising temperatures open again and effectuate systematic ventilation. This kind of ventilation inserts must be capable of being manufactured in a simple manner as to design, be cost-effective, and be made from materials that do not endanger health.

The task is solved according to the invention by a ventilation insert for ventilation of textiles, shoes and soles of shoes, gloves, protective goggles, insulating mats, cushioning mats, knee pads and shin pads, headgear and similar articles, characterized in that an open-pored carrier layer is provided with an open-pored cover or individual covering elements that at least in part consist of material that undergoes a swelling or shrinking effect or change of form at least by means of a fluid, moisture, a temperature differential, or an electrical voltage or such a material is connected with the carrier layer, the cover, and/or a covering element or represents the carrier layer or cover so that opening or closing of ventilation openings in the carrier layer and/or cover occurs through swelling or shrinking or change in form. Further embodiments are the object of dependent claims or are described in the following.

Accordingly, an open-pored carrier layer with an open-pored cover or with individual covering elements is provided for the ventilation insert according to the invention that at least in part consists of a material that undergoes a swelling or shrinking effect or change of form through moisture, a change of temperature, or electrical voltage or such a material is connected with the carrier layer, the cover, and/or the covering elements or constitutes the carrier layer or cover so that opening or closing of ventilation openings in the carrier layer and/or the cover occurs by means of swelling or shrinking.

The material capable of swelling may be a granulate or pieces of flat material or a material formed from filiform material. It may be a fluid absorbent, preferably a granulate fluid absorbent of cross-linked sodium poly acrylate, a poly acrylate acid copolymer, a protein, or casein. A thermoplastic elastomer composite material that swells with moisture is, for example, available from the Fraunhofer Institute under the name Q-TE-C. Shape memory alloys or thermoplastic elastomer composites can be used as material that changes form due to heat or electrical voltage.

The carrier layer can, for example, be a fleece material onto which the material that swells is attached. The carrier layer can also consist of the following materials or mixtures: polymer compounds, thermoplastic elastomer composite, materials from animals such as bones, horn, fibers, vegetable materials such as coconut husks, wood, herbs, fibers, carbon compound composite materials such as carbon, metal, mineral composites, ceramics, magnetic materials, glass, rubber, resins, leather, cardboard and/or protein composites. The materials are either shaped by injection moulding or combined with plastic materials.

The cover can also be a fleece material or a plastic or metal grid.

The arrangement can be multiply built up to strengthen the opening and closing effect.

The cover can at the same time serve as a surface for evaporation or attraction of moisture.

Reversible swelling of moisture absorbents, such as cross-linked sodium poly acrylate, proteins, or casein, caused by moisture is used with the invention independently to close or open the ventilation openings, whereby they are capable of automatically reversing the motion. The swelling or shrinking of the absorbent materials is used to cause simple mechanical movement and thus ventilation.

Polymers with reversible phase transformation also come into question as material that swells. The interstices within this material that may be of fleece or fiber material or granulate applied to such material are triggered by the reaction of such memory alloys through moisture, heat, or an electrical voltage and at least partially closed. A self-regulating ventilation insert can, for example, be made with a heat-sensitive polymer that automatically closes the ventilation opening with a low external temperature or opens it with a high temperature. Suitable plastics are already available, especially plastics that have a so-called “shape memory effect.”

According to a first exemplary variant, a provision is made that covering elements connected on one of their ends by adhesive or thermoplastic bonding with the carrier layer can be folded in the manner of a butt hinge by the swelling or shrinking of a material that swells connected with the carrier lay or the covering elements and thus, depending on the direction of movement, can release or cover the ventilation opening in the cover or the upper surface of a fiber layer that is permeable to air and vapor.

In the vicinity of the hinge there is, for example, an elastic casing permeable to fluid, a vapor and fluid absorbent like, for example, cross-linked sodium poly acrylate, or a thermoplastic elastomer composite material that may also be formed material. The ventilation openings or fiber layers permeable to vapor are located in the vicinity of the hinge and allow penetration of fluid and a rapid release of water vapor. If moisture penetrates the casing surrounding the fluid and vapor absorbent, which prevents loss of the vapor absorbent, the vapor absorbent absorbs the fluid. The covering element rises or sinks depending on the design and on the absorption of fluid and the swelling associated with it (at least 50 g per m² cm). If the vapor absorbent is above the hinge, the covering element is depressed with absorption of fluid. If, on the other hand, the vapor absorbent is on the bottom side of the covering element, the covering element rises with absorption of fluid. The volume of the vapor absorbent is reduced by evaporation of the absorbed fluid and the movement reverses due to the reset force of the covering element, the elastic casing, the shrinking of the absorbent, and/or that of the hinge. Loss of the fluid and vapor absorbent can be prevented by retainers.

Anchor points such as a joint face, adhesive face or hook-and-loop face, or seam can be located on a frame of the carrier layer and/or cover that make it possible to hold the ventilation insert in the desired position above the penetrations or openings in the material of the ventilated object. Manufacture of the joint faces can be done in different strengths depending on the area of use. The faces are preferably thin and converge to the surface at 0. The joint faces can preferably be textured already during the injection moulding process or afterwards by mechanical buffing, etching, radiating with UV light, or treatment with a gas like ozone. An upper surface of the joint face textured accordingly eases fixing to the ventilated object if means of adhesion are selected such as gluing, bonding, or similar. The frame can also serve for thermoplastic bonding with the ventilated object.

According to a further design of the invention, the circumstance is used that the permeability of air and water of two open-pored materials lying over each other (carrier layer and cover with air openings or a fiber layer permeable to air and vapor) is interrupted when there is a material that swells between them, for example an absorbent granulate or a thermoplastic elastomer composite that also may be of flat material that, when dry, allows air circulation through the layering. An increase of volume caused by fluid seals the interstices that occur between these two layers lying over each other against water. When dry, the volume of the vapor absorbent is again reduced and air can circulate through the interstices. The two materials lying over each other prevent loss of the absorbent granulate or similar material and limit the space available to the material when swelling occurs, which results in compaction and impermeability of air and water.

After further design of the invention the carrier layer or cover itself consists of the material that swells and the ventilated openings are dimensioned such that they are closed during the swollen phase of the swelling material.

In a given case the swelling material can be supplemented by a spacing material such as cork or plastic granulate or fibers. Other spacing materials can be used, for example polymer compounds, thermoplastic elastomer composite, coal, animal fibers like hair, down, leather, bones, horn, vegetable fiber like cotton, cellulose, cardboard, linen, coconut husks, wood, fibers, herbal, metallic, or mineral materials also in other forms than in fiber form, carbon fiber fabrics, rubber, etc, materials or mixtures of them, powder or granulate or materials with heat-retention characteristics, for example micro-encapsulated wax.

The cover elements are preferably connected on their edges by an adhesive, for example, with a material that flows at the time of manufacture or by thermoplastic bonding so that a frame is formed and leakage of the vapor absorbent to the outside is prevented. The adhesion can in a given case also be across the entire surface area.

Anchorages like joint faces, adhesion surfaces, or seams can be located on the frame that make it possible to hold the ventilation insert above penetrations or openings in the material at a desired position in the object. Air can circulate through the ventilation insert under dry conditions. The connection to the joint faces can be made, for example by means of magnetic force, snap fitting, plug connection, with material that flows at the time of manufacture, slide connection, glued connection, folded joint, thermoplastic bonding, or seams.

If moisture enters the ventilation insert, the moisture or vapor absorbent removes it. The interstice between the carrier layer and cover is made to be waterproof because of the absorption of moisture and the associated increase in volume. If the introduction of moisture is interrupted, the moisture already absorbed evaporates, the volume of the vapor absorbent decreases, and air can again circulate in through the ventilation insert.

The swelling characteristics of vapor absorbents are almost completely reversible with cross-linked sodium poly acrylate or a plastic that swells.

The permeability of a vapor absorbent to vapor can be controlled by a protective layer that can be a paint, for example. This is sensible especially when a flat vapor absorbent is present that swells with moisture and the edges serve to limit the extent and do not themselves swell.

The invention will be illustrated in more detail below. The drawings show:

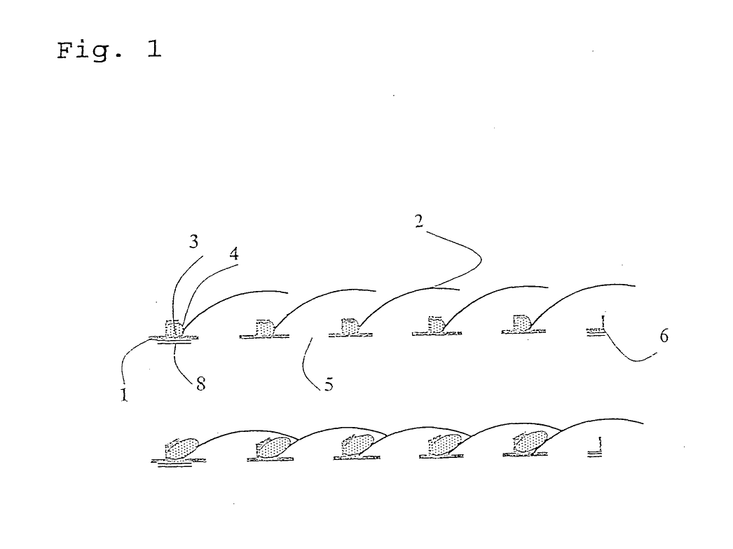

FIG. 1 a cross-section through a first variant of a ventilation insert under dry and moist conditions,

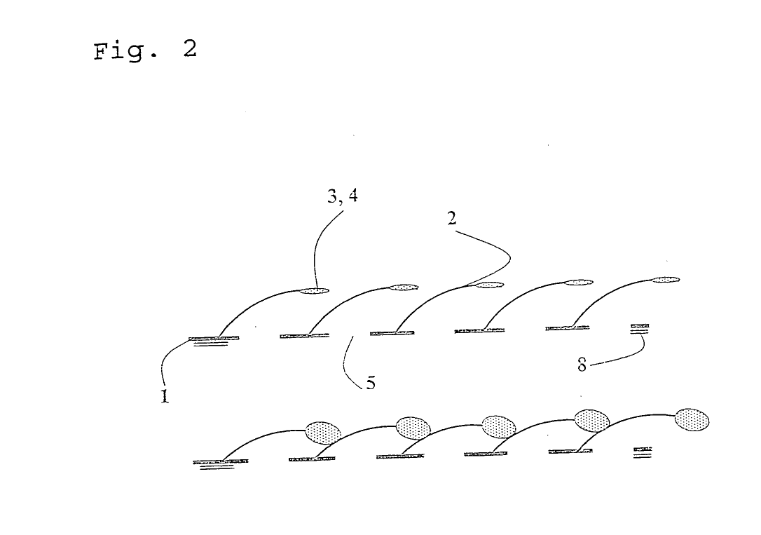

FIG. 2 a cross-section through a second variant of a ventilation insert under dry and moist conditions,

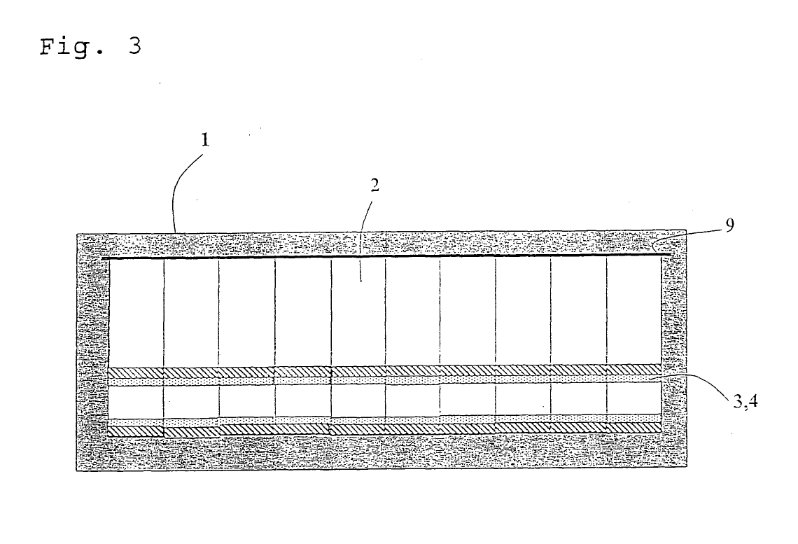

FIG. 3 a top view of a ventilation insert according to FIG. 2,

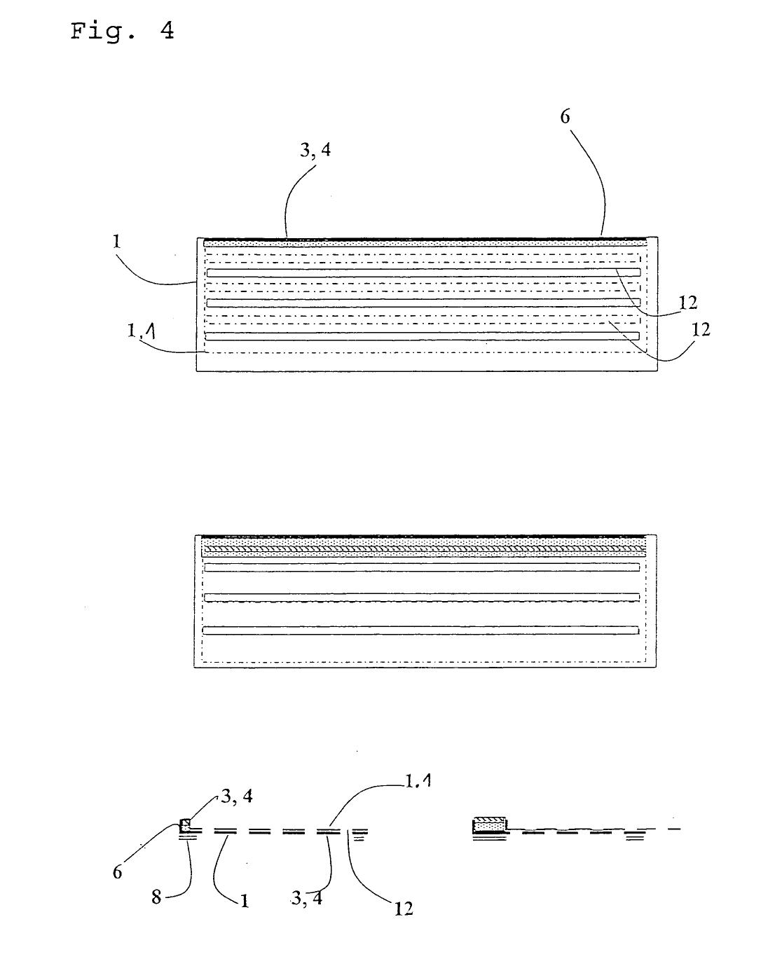

FIG. 4 a top and cross-sectional view of a ventilation insert for textiles or for shoes with movable covers under both dry and moist conditions,

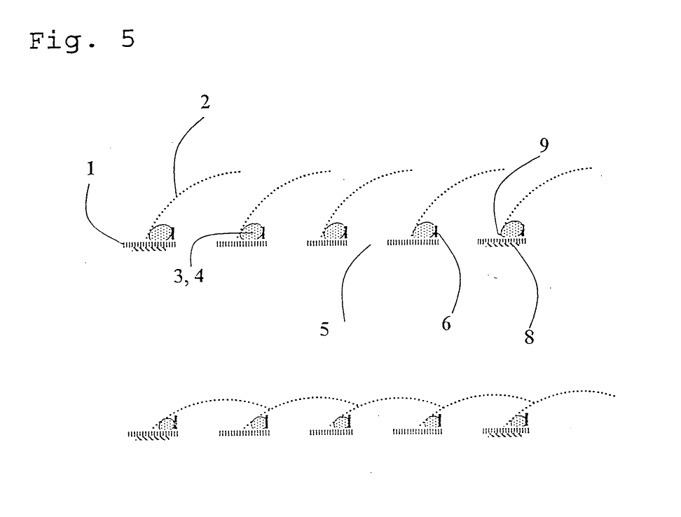

FIG. 5 a cross-section through a fourth variant of a ventilation insert under dry and moist conditions,

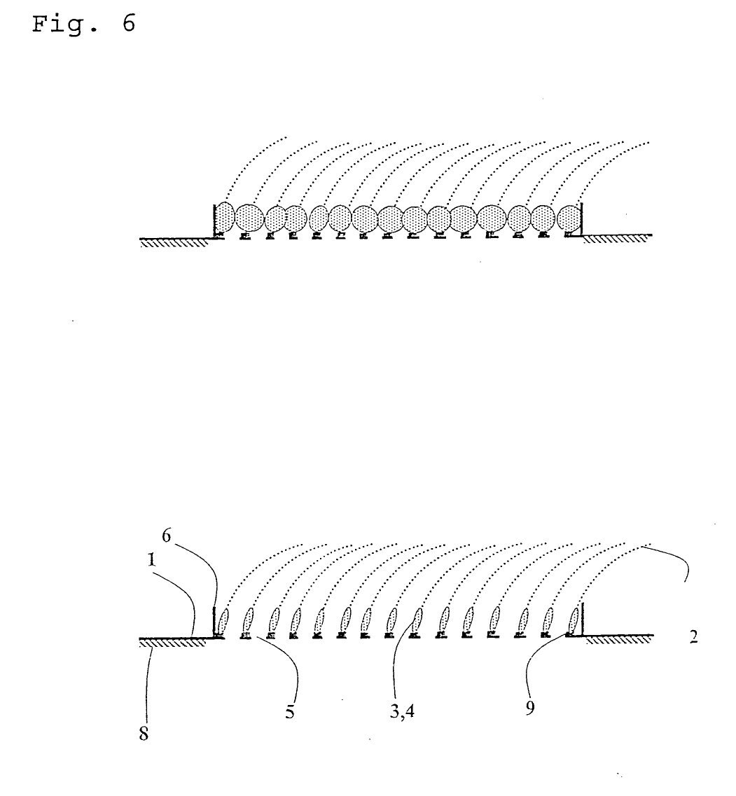

FIG. 6 a cross-section through a fifth variant of a ventilation insert under dry and moist conditions,

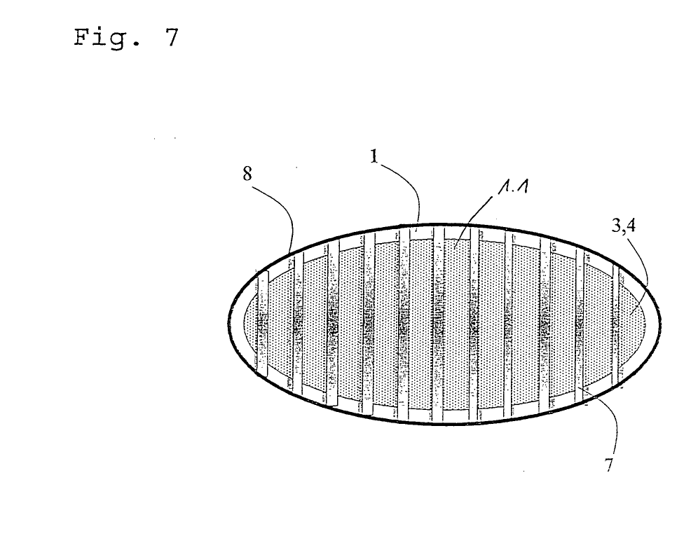

FIG. 7 a plan view of a large-area ventilation insert,

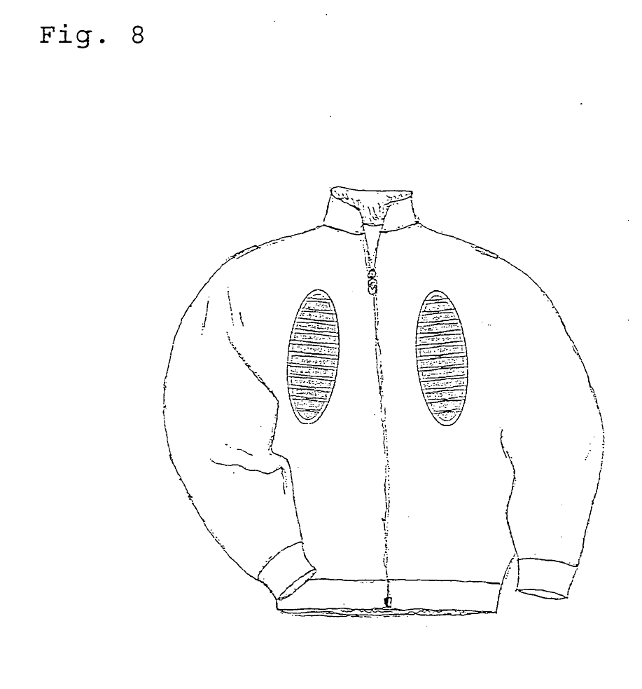

FIG. 8 an example of a design for a ventilation insert,

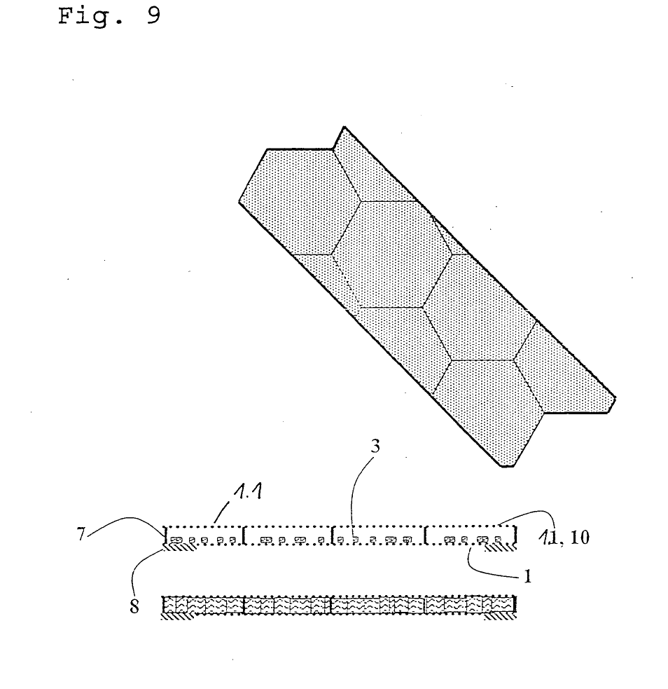

FIG. 9 a plan view of a ventilation insert with honeycombed braces and a cross-sectional view under dry and moist conditions,

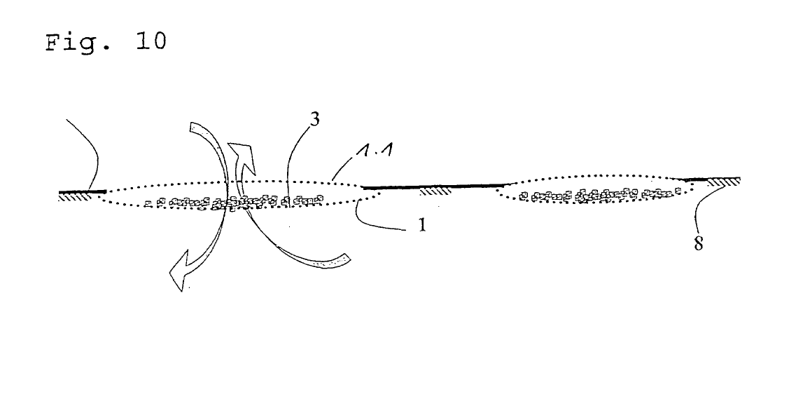

FIG. 10 an example of a ventilation insert according to the invention in an inserted sole or shoe sole.

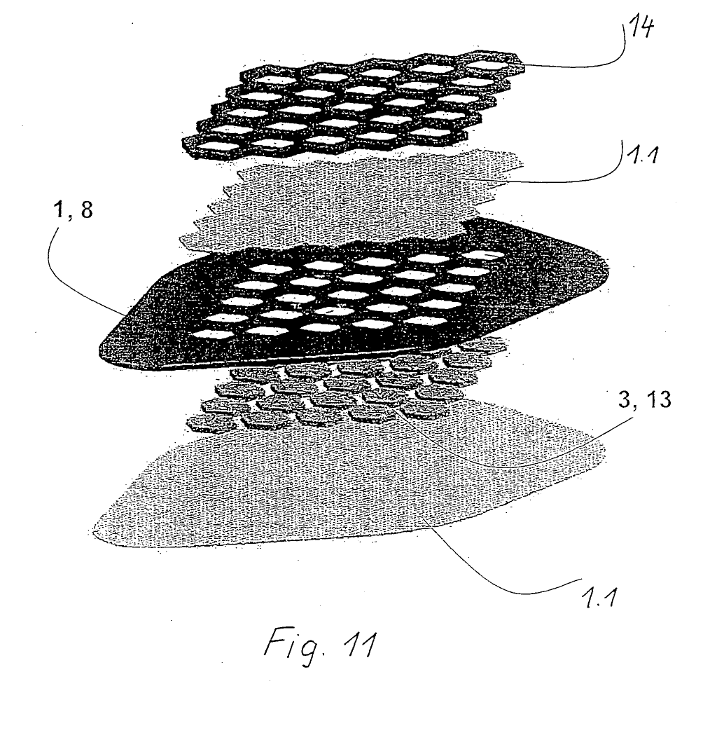

FIG. 11 a further example of a ventilation insert in exploded view,

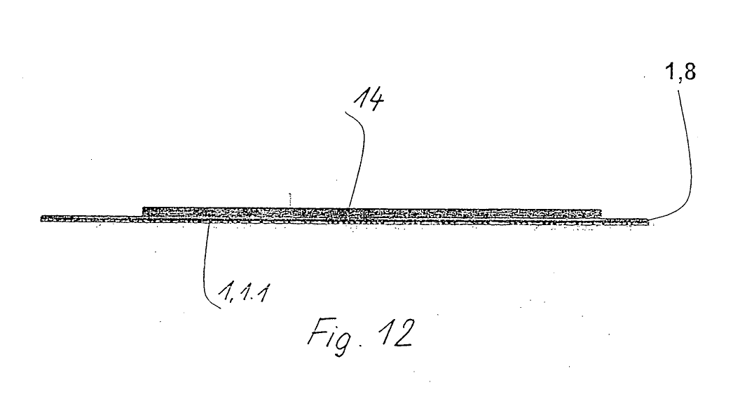

FIG. 12 the ventilation insert according to FIG. 11 in side view,

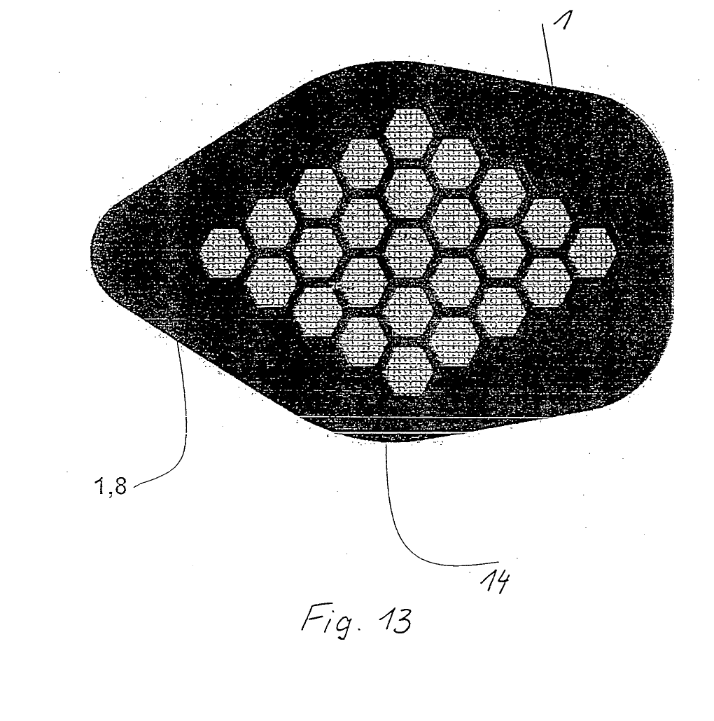

FIG. 13 the ventilation insert according to FIG. 11 in top view,

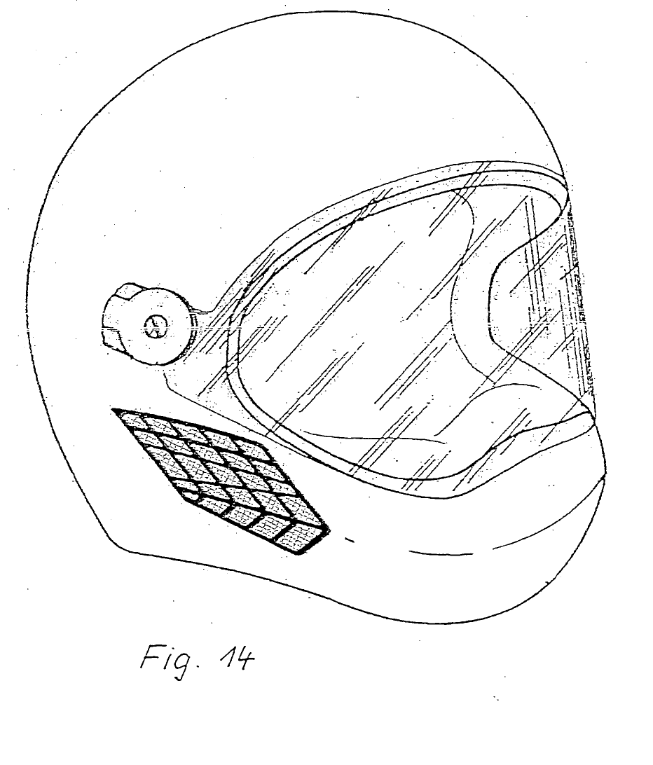

FIG. 14 the ventilation insert according to FIG. 11 inserted in a protective helmet,

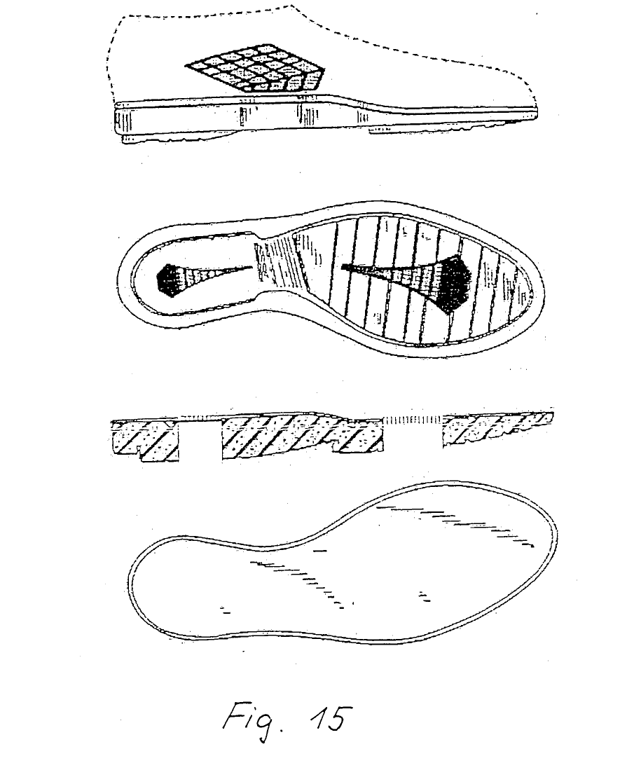

FIG. 15 the ventilation insert according to FIG. 11 inserted in a shoe,

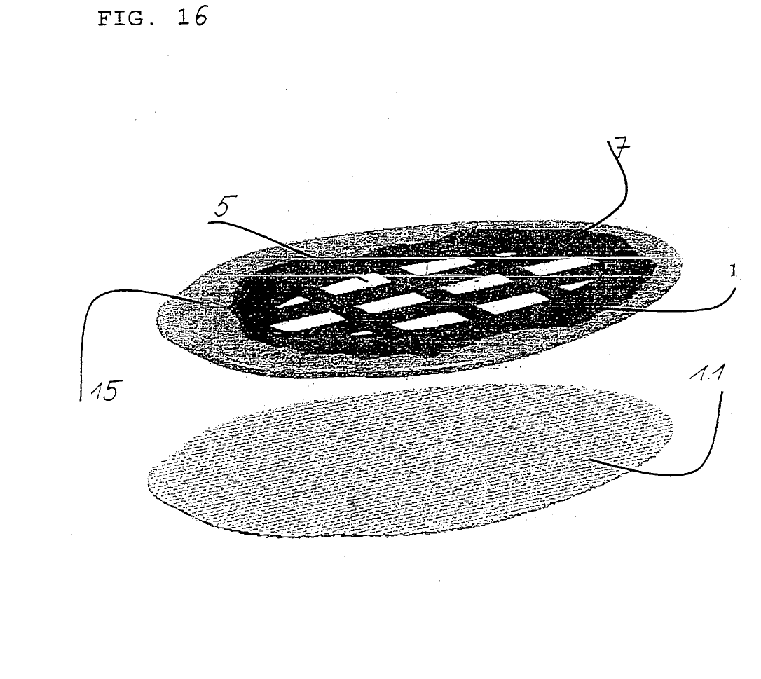

FIG. 16 a further ventilation insert in non-activated condition, and

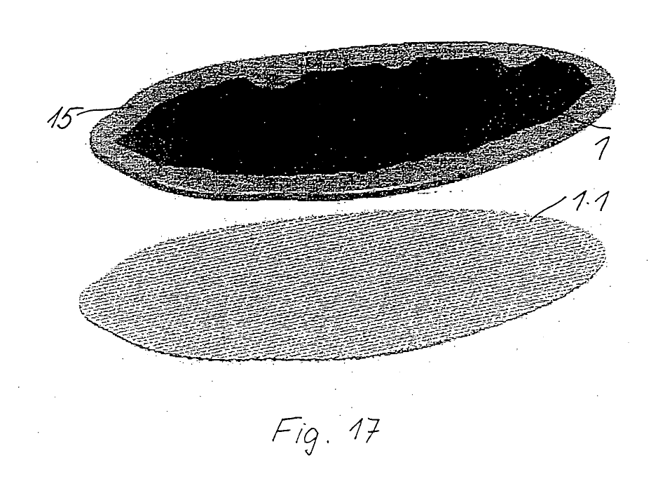

FIG. 17 the ventilation insert according to FIG. 16 in activated condition.

FIG. 1 schematically shows a ventilation insert with a carrier layer 1 that later faces inward in the object to be ventilated and is provided with ventilation openings 5. Casings 4, in which a vapor adsorbent 3 is contained, are held by retainers 6 on the carrier layer. Covering elements 1 are connected with casing 4 so that they unfold like a hinge with expansion of vapor absorbent 3. Anchorages 8 are provided on the edge of carrier layer 1, for example an adhesive surface. Covering elements should be made of a waterproof material permeable to vapor.

In this first variant the swelling property of vapor absorbent 3 is used through its absorption of moisture to fold covering element 2 down or up and thus to close ventilation opening 5. It opens again by reset force due to evaporation of the moisture absorbed previously.

FIG. 2 shows a similar layout only that casings 4 are located on the ends of covering elements 2 that face towards the outside. The ventilation effect is based here on the increase in weight of vapor absorbent 3 that makes covering elements 2 fold down or with elastic reset fold up with evaporation of the moisture.

FIG. 3 shows the layout from above.

FIG. 4 shows a variant for use on textiles or the upper part of shoes. Here there is a cover 1.1 on a carrier layer 1, whereby both have passages 12 at the same height. At least one of the two is made to be movable and is located on at least one side in connection with vapor absorbent 3 and casing 4. Contingent on the swelling of vapor absorbent 3, cover 1.1 can be displaced, whereby the face of the cut of passages 12 simultaneously moves.

FIG. 5 shows covering elements 2 arranged in a strip where casings 4 with vapor absorbent 3 are situated on the level of hinge 9. Covering elements 2 are used here for transport of fluid in the direction of vapor absorbent 3. Fluid can come into contact with vapor absorbent 3 via covering elements 2. At the same time covering elements 2 act as evaporation surfaces for faster drying of vapor absorbent 3.

FIG. 6 shows a variant according to which the swelling property of vapor absorbent 3 is used directly to close ventilation openings 5 in covering layer 1. Covering elements 2 are connected here with casings 4 of vapor absorbent 3 and prevent moistening from an external source.

FIG. 7 shows a large-surface ventilation insert. Braces 7 were employed here to limit an interstice 11 between carrier layer 1 and cover 1.1.

Attachment of a ventilation insert in a jacket is shown in FIG. 8.

According to the variant in FIG. 9, carrier layer 1 and cover 1.1 are connected with braces 7 in honeycombed array that may be made from the material of carrier layer 1 by cut-out material. Closing ventilation openings 5 in carrier layer 1 and cover 1.1 is done directly by the swelling property of vapor absorbent 3. Cover 1.1 can be a fiber layer (10) permeable to air and vapor.

In FIG. 10 a ventilation insert is shown that is located inside a shoe sole and protects against water penetration. In this example of an embodiment cover 1.1, consisting for example of a soft polymer like TPR or Nylon, forms a capsule with carrier layer 1 that has ventilation openings 5. There is an interstice 11 between covers 1.1 and carrier layer 1 into which vapor absorbent 3 is put.

FIGS. 11 to 13 show a ventilation insert with a carrier layer 1 that on both sides has a cover 1.1 of fleece material, whereby a vapor absorbent 3 of thermoplastic elastomer composite and filler 13 are applied to lower cover 1.1. Cork or plastic granulate is suitable as filler, whereby use of intelligent polymers that react to heat is possible for the latter. There is a protective grid 14 on the outside. Protective grid 14 prevents damage to cover 1.1. It can be manufactured by injection moulding and connected with carrier material 1 through cover 1.1.

FIG. 14 shows the ventilation insert used in a protective helmet. FIG. 15 shows use in a shoe.

FIGS. 16 and 17 show a further variant. Here the grid-formed carrier layer 1 itself is composed of vapor absorbent 3, in this case of thermoplastic elastomer composite. The ventilation openings (5) are between braces 7 forming the grid. Penetration of dirt is prevented by a cover 1.1. It simultaneously serves as an evaporation surface. If moisture impinges on braces 7, they swell up and ventilation openings 5 gradually close until they are watertight. Surfaces remain on the surrounding edge for anchorages 8 on the article to be ventilated. The anchorage surfaces' property of swelling is diminished or completely stopped by a waterproof protective layer 15.

### REFERENCE LIST

1. Carrier layer
1.1 Cover
2. Covering element
3. Vapor absorbent
4. Casing
5. Ventilate opening
6. Retainer
7. Brace
8. Anchorage
9. Hinge
10. Fiber layer
11. Interstice
12. Passage
13. Filler
14. Protective grid
15. Protective layer

1. A ventilation insert for ventilation of textiles, shoes and shoe soles, gloves, protective helmets and their visors, protective goggles, insulating mats, cushioning mats, knee pads and shin pads, headgear and similar articles characterized in that
an open-pored carrier layer (1) is provided with an open-pored cover (1.1, 10) or individual covering elements (2) that at least in part consist of a material (3) that undergoes swelling or shrinking or a change in form brought about by at least a fluid, moisture, a difference in temperature, or an electrical voltage or
such a material (3) connected with carrier layer (1), cover (1.1, 10), and/or covering elements (2) or forms the carrier layer or cover, in that opening or closing of ventilation openings (5, 12) is accomplished by the swelling or shrinking or change in form of carrier layer (1) and/or cover (1.1, 10).

2. A ventilation insert according to claim 1, characterized in that the material (3) is a granulate or granulate-formed fluid absorbent.

3. A ventilation insert according to claim 1, characterized in that the material (3) is lumpy flat material.

4. A ventilation insert according to claim 1, characterized in that the material (3) is filiform.

5. A ventilation insert according to any one of the above claims, characterized in that carrier layer (1) itself is of material (3) with swelling properties and its ventilation openings (5) are so dimensioned that they are closed when the material (3) with swelling properties is in a swollen condition.

6. A ventilation insert according to claim 5, characterized in that a surrounding surface for anchorages (8) for the carrier layer (1) is provided with a waterproof protective layer (15).

7. A ventilation insert according to any one of the above claims, characterized in that material (3) with swelling properties is a vapor absorbent of cross-linked sodium poly acrylate or a poly acrylic acid copolymer.

8. A ventilation insert according to any one of claims 1 to 4, characterized in that material (3) that changes form is a shape memory alloy.

9. A ventilation insert according to any one of the above claims, characterized in that carrier layer (1) consists of a fleece material.

10. A ventilation insert according to any one of the above claims, characterized in that it is built up in multiple layers.

11. A ventilation insert according to any one of the above claims, characterized in that covering elements (2) are connected on one of their ends with carrier layer (1) so that they can be folded like a hinge (9) by effects of swelling or shrinking or change of form of a material (3) connected with carrier layer (1) or the covering elements (2) and thereby uncover or cover ventilation openings (5) in carrier layer (1).

12. A ventilation insert according to claim 11, characterized in that covering elements (2) are connected with cover (1) by adhesion or by thermoplastic bonding with a material that is capable of flowing at the time of manufacture.

13. A ventilation insert according to claim 11 or 12, characterized in that material (3) is inserted in an elastic casing (4) that is permeable to fluids.

14. A ventilation insert according to claim 13, characterized in that the elastic casings (4) are held on cover (1) by retainers (6).

15. A ventilation insert according to any one of claims 14 to 17, characterized in that material (3) is located in the vicinity of hinge (9).

16. A ventilation insert according to any one of claims 11 to 14, characterized in that material (3) is located in the area of the ends of covering elements (2) facing outward.

17. A ventilation insert according to any one of claims 11 to 16, characterized in that covering elements (2) are arranged in strips.

18. A ventilation insert according to any one of the above claims, characterized in that cover (1) and covering elements (2) are connected with each on their edges by adhesion or thermoplastic bonding and/or by connecting with a material capable of flowing at the time of manufacture in a way that they form a frame.

19. A ventilation insert according to any one of the above claims, characterized in that material (3) capable of swelling is inserted into interstice (11) between carrier layer (1) and a cover (1.1).

20. A ventilation insert according to any one of the above claims, characterized in that carrier layer (1) and cover (1.1) are connected with each other on their edges by adhesion or thermoplastic bonding and/or by connecting with a material capable of flowing at the time of manufacture in a way that they form a frame.

21. A ventilation insert according to claim 19 or 20, characterized in that carrier layer (1) and cover (1.1) are separated from each other by braces (7).

22. A ventilation insert according to claim 21, characterized in that braces (7) have a honeycombed form.

23. A ventilation insert according to claim 21, characterized in that braces (7) are in the form of a grid.

24. A ventilation insert according to any one of the above claims, characterized in that carrier layer (1) and cover (1.1) are provided with congruent passages (12) and that carrier layer (1) or cover (1.1) is connected with material (3) capable of swelling and is movable through the effect of material (3) capable of swelling when swollen to close passages (12).

25. A ventilation insert according to any one of the above claims, characterized in that anchorages (8) like adhesion surfaces or seams are located on or at the frame.

26. A ventilation insert according to any one of the above claims, characterized in that cover (1.1) is covered by a protective grid.

27. A ventilation insert according to any one of the above claims, characterized in that a filler (13) is mixed in with material (3) capable of swelling.

28. A ventilation insert according to any one of claims 13 to 27, characterized in that material (3) capable of swelling is held with retainers (6) on cover (1).

29. Use of the ventilation insert according to any one of the above claims for ventilation of textiles, shoes and shoe soles, gloves, protective helmets, protective goggles, head coverings, insulating mats, cushioning mats, knee and shin protectors.
